(19) United States
(12) Patent Application Publication
(10) Pub. No.: US 2010/0329491 A1
(43) Pub. Date: Dec. 30, 2010

(54) SYSTEM FOR TRANSMITTING AMPLIFIED AUDIO SIGNALS TO A USER

(75) Inventor: Morten Kjaer Johansen, Smorum (DK)

Correspondence Address: BIRCH STEWART KOLASCH & BIRCH, PO BOX 747, FALLS CHURCH, VA, 22040-0747, US

(73) Assignee: PHONIC EAR A/S, Smorum (DK)

(21) Appl. No.: 12/864,830

(22) PCT Filed: Mar. 26, 2009
(86) PCT No.: PCT/EP2009/053612

§ 371 Date: Jul. 27, 2010

(30) Foreign Application Priority Data
Mar. 31, 2008 (EP) 08103196.5

(51) Int. Cl. H04R 25/00; H04B 3/00; H04B 7/00

(52) U.S. Cl. 381/315; 381/77; 455/41.2

(57) ABSTRACT

Disclosed is a system for transmitting amplified audio signals to a user, wherein the system comprises a receiver unit, a transmitter unit and a base unit, wherein
the receiver unit is adapted to receive audio signals wirelessly from at least one of the transmitter unit and the base unit and from one or more external devices, and where the receiver unit is adapted to be worn by the user;
the transmitter unit is adapted to transmit audio signals wirelessly to the receiver unit; and
the base unit is adapted to communicate with one or more external devices and adapted to communicate wirelessly with the receiver unit.

### FIELD OF THE INVENTION

This invention relates to a system for transmitting amplified audio signals to a user.

### BACKGROUND OF THE INVENTION

Hearing impaired persons may wish to use a hearing aid or other means for having audio signals amplified. For hearing aid users background noise may be a problem, because background noise may reduce the hearing aid user's ability to recognize sounds. However, if the signal-to-noise ratio is improved, by means of a hearing assistive device, sound recognition may be possible even in the presence of background noise. The least interference from background noise occurs if speech is transmitted directly from the lips of a person speaking to the ear of the hearing-impaired person [Kim and Barrs; Hearing aids: A review of what's new, Otolaryngology—Head and Neck Surgery (2006), 134, 1043-1050]. Induction loops, FM transmissions systems, direct auditory input or Bluetooth technology may provide a direct transmission of sound from a speaking person to a hearing aid user.

Induction loops can be used in auditoriums that are looped by a wire at the walls. The lecturer's voice is transmitted from a microphone to the induction loop wire. A hearing impaired person may wear a loop receiver sensing the magnetic field and converting it to an electrical signal to drive a pair of headphones reproducing the auditory signal directly to the person's ear. A telecoil pickup inside a hearing aid uses the same technology to detect the magnetic field from a room loop wire. Likewise coil-based telephone receivers or other smaller coil-based speakers connect inductively to the hearing aid at small range. In any case the sound is transmitted directly to the hearing aid rather than being transmitted acoustically through the air captured by the hearing aids microphone. Generally, any telephone with a coil-based speaker is hearing aid compatible by means of a telecoil, however most telephones which are enhanced for hearing impaired persons are equipped with an extra inductive coil at the receiver to provide a stronger magnetic field. Cordless phones can be hearing aid compatible, but the majority of them still are not. Cellular phones do not generate the magnetic field required for telecoil use but adaptors exist that can be plugged into a cell phone to make it hearing aid compatible.

With an FM system, the lecturer wears a transmitter to send the signal by radio frequency transmission to a receiver worn by the hearing-impaired person. The FM receiver can be attached to the hearing aid by a boot, usually on the bottom of the aid, or can be incorporated into the hearing aid itself. An audio signal can also be hooked into the hearing aid directly by a wire, called direct audio input.

U.S. Pat. No. 3,742,359 describes a device to be worn by a hard-of-hearing person wherein a radio receiver with an antenna, encircling the waist of the person, to pick up radio frequency signals, is housed in a case having a chamber into which a pocket-type hearing aid with input induction coil may be inserted. An output induction coil encircles the chamber and is connected to the output terminals of the radio receiver. A radio signal transmitted from a transmitter unit held by an instructor is received by the radio receiver and converted to an audio frequency output signal which is conducted to the output induction coil. When the hearing aid is in the chamber, the hard-of-hearing person is permitted to hear the audio frequency output signal over his hearing aid.

U.S. Pat. No. 4,004,229 describes an apparatus with a button adapted to fit in the ear cavity; a hook for attaching the button to the ear; and an AM radio receiver housed in the button. The radio receiver comprises an antenna tuned to intercept a radio signal in the AM frequency band, the antenna having a coil wrapped around an insulated core and a capacitor connected with the coil, means for producing an audio signal from the radio signal intercepted by the antenna, and a battery to provide power for the radio receiver.

EP 0789474 describes a hand-free arrangement for a mobile communication device containing a first connection for a transmitted audio signal and a second connection for a received audio signal. The arrangement further includes a combination of an induction loop, a microphone and means for connecting the induction loop to the first connection and for connecting the microphone to the second connection; and an earphone device located in the ear of the user, which includes at least an earphone and an inductive device connected to the earphone for receiving a signal. The earphone device may be a hearing aid equipped with a telephone coil.

U.S. 2006/0039577 describes an apparatus for communication involving a hearing assistance device having a first antenna and a remote wireless device, comprising a first wireless circuit adapted for connection to a second antenna to conduct inductive communications with the first antenna; a second wireless circuit adapted for radio frequency communications; a controller in communication with the first wireless circuit and the second wireless circuit; a microphone in communication with the controller; and a power source to provide power to the apparatus.

It remains a problem to improve the transmission of amplified audio signals to hearing impaired persons.

### SUMMARY

Disclosed is a system for transmitting amplified audio signals to a user, the system comprising a receiver unit, a transmitter unit and a base unit, wherein
the receiver unit is adapted to receive audio signals wirelessly from at least one of the transmitter unit and the base unit and from one or more external devices, and where the receiver unit is adapted to be worn by the user;
the transmitter unit is adapted to transmit audio signals wirelessly to the receiver unit; and
the base unit is adapted to communicate with one or more external devices and adapted to communicate wirelessly with the receiver unit.

Consequently, it is an advantage that the user of the system has the opportunity to receive amplified audio signals from different sound sources by using the system described herein. The system provides the user with the opportunity to receive and have telephones calls, receive sound from one or more persons that are talking, and receive sound from other sound sources in different devices. Furthermore, the user may easily switch between the different sound sources when this is appropriate for the user. The system enables the user to have telephone conversations both in a fixed network telephone and in mobile phones, to watch TV and receive amplified sound from the TV simultaneously, to listen to music, radio etc. The units of the system work together to provide the user with the possibility to receive amplified sound from a plurality of sound sources and devices, whereby the user can achieve optimal listening conditions in many different listening situations.

In one embodiment the system is adapted to be used together with a hearing aid. An advantage of this embodiment is that the system can be used by hearing aid users, which wear a hearing aid on one or both ears. The system may be used with any hearing aid equipped with telecoil regardless of brand and model of the hearing aid. Furthermore, the system may work with binaural hearing aid fitting where two hearing aids are worn simultaneously, one hearing aid on each ear.

In one embodiment the system is adapted to be used together with headphones. An advantage of this embodiment is that the system can be used by hearing impaired users, which do not wear a hearing aid.

In one embodiment the units are adapted to communicate by means of radio frequency communications.

In one embodiment the radio frequency communications is by means of Bluetooth radio frequency communication. It is an advantage to use Bluetooth communications because Bluetooth enables devices with a Bluetooth chip to communicate with each other when they are in range. Many mobile phones and other devices have Bluetooth communications means. Pairing and connection between Bluetooth devices is simple and may be performed automatically, when Bluetooth devices are within range of each other.

In one embodiment the radio frequency communications is by means of a wireless digital audio system operating in the 2.4 GHz band. An advantage of using a wireless digital audio system with frequency range in the 2.4 GHz band is that this band is unlicensed worldwide and thus may be used to provide communications between different devices.

In one embodiment the radio frequency communications has an ultra low latency, such as a latency of less than 10 milliseconds. An advantage of this embodiment is that when the communications has an ultra low latency, audio signals will not be substantially delayed to create a noticeable delay for the user and thus echo effects do not occur. In one embodiment a base unit for use in the system is adapted to be stationary arranged. It is an advantage that the base unit is stationary arranged, because the base unit may be connected to a number of external devices such as a TV, a fixed network telephone etc.

In one embodiment a transmitter unit for use in the system is arranged in a position from the group consisting of:
held by a second person;
worn by a second person;
held by the user;
worn by the user;
placed in the base unit;
placed on a surface.

It is an advantage that the transmitter unit is held or worn by a second person or the user or placed on a surface, when the transmitter unit is used for transmitting and amplifying audio signals in a conversation between the user and the second person and e.g. other persons, or when the user wishes to listen to a lecturer and/or the like. However, when the transmitter unit is used for transmitting sound from a TV, the transmitter is placed in the base unit for transmitting wireless digital audio signals to the receiver unit.

In one embodiment a receiver unit for use in the system is adapted to be worn in a neckloop around the neck of the user. It is an advantage that the receiver unit is worn in a neckloop around the user's neck, since the neckloop may carry and place the receiver unit in a suitable position for transmitting audio signals to the user.

In one embodiment the neckloop comprises magnetic means for providing communication. It is an advantage that the neckloop comprises magnetic means for communication, since hereby the magnetic means may provide communications with a hearing aid, which the user wears.

In one embodiment a receiver unit for use in the system is adapted to communicate with a hearing aid worn by the user by means of said magnetic means.

In one embodiment a receiver unit for use in the system comprises a Bluetooth receiver. An advantage of this embodiment is that the receiver unit may receive audio signals from a device with a Bluetooth chip, e.g. the base unit, a mobile phone etc.

In one embodiment a receiver unit for use in the system comprises a Bluetooth transmitter. An advantage of this embodiment is that the receiver unit may transmit audio signals to a device with a Bluetooth chip, e.g. the base unit, a mobile phone etc

In one embodiment a receiver unit for use in the system comprises a wireless digital audio receiver with frequency range in the 2.4 GHz band. An advantage of this embodiment is that the receiver unit may receive audio signals from a device with wireless digital audio transmission means, e.g. the transmitter unit.

In one embodiment a transmitter unit for use in the system comprises a wireless digital audio transmitter with frequency range in the 2.4 GHz band. An advantage of this embodiment is that the transmitter unit may transmit audio signals to a device with wireless digital audio receiving means, e.g. the receiver unit. Wireless digital audio communications may be used when receiving audio signals from a television, and this is an advantage since wireless digital audio transmission may provide an ultra low latency of e.g. less than 10 milliseconds and thus may not delay the audio signals, whereas other radio frequency transmissions may not have an ultra low latency and thus may delay the audio signals. If an audio signal is delayed, the user will hear an echo, if the user hears both the unamplified audio signals and the amplified audio signals through his/her hearing aid or headphones. Furthermore, even if the user only hears the delayed audio signals through his/her hearing aid(s) or headphones, the delayed audio signal will not be in accordance with what the user can watch on the TV screen with regard to lip reading or speech reading, which the user may perform. Thus wireless digital audio transmission with an ultra low latency of less than e.g. 10 milliseconds may be used for transmitting audio signals from a television to the receiver unit.

In embodiments a transmitter unit for use in the system comprises an omni-directional microphone for capturing sound waves from a plurality of directions and converting them to electrical audio signals.

In embodiments a transmitter unit for use in the system comprises a directional microphone for capturing sound waves from one direction and converting them to electrical audio signals.

In one embodiment a base unit for use in the system comprises a charger unit adapted to charge the receiver unit and the transmitter unit. It is an advantage that the base unit may provide charging of the transmitter unit and the receiver unit, since this will eliminate the need for a separate charger unit.

In one embodiment a base unit for use in the system comprises a Bluetooth receiver. It is an advantage of this embodiment that the base unit may receive audio signals from a device with a Bluetooth chip, e.g. the receiver unit, a mobile phone etc.

In one embodiment a base unit for use in the system comprises a Bluetooth transmitter. It is an advantage of this embodiment that the base unit may transmit audio signals to a device with a Bluetooth chip, e.g. the receiver unit, a mobile phone etc.

In one embodiment a base unit for use in the system comprises a wireless digital audio channel management system for pairing the transmitter unit and the receiver unit to the same communications channel.

In one embodiment a base unit for use in the system comprises means for receiving audio signals from an external device through an audio line input. It is an advantage that audio signals can be received through the base unit, since hereby the audio signals can be transmitted to the receiver unit.

In one embodiment a base unit for use in the system comprises means for receiving audio signals from a television. It is an advantage that the user can receive amplified audio signals from a TV by means of the system described herein.

In one embodiment a base unit for use in the system comprises means for transmitting and receiving audio signals to and from a fixed network telephone. It is an advantage that the user can receive amplified audio signals from a fixed network telephone by means of the system described herein.

In embodiments of the system external device(s) is/are from the group consisting of, but not limited to:
a mobile phone;
a fixed network telephone;
a television;
a radio receiver;
a music player;
a Bluetooth headset.

It is an advantage that the user can receive amplified audio signals from a variety of sound source devices, since hereby the user only need to use the system described herein for receiving and having audio signals amplified from many sound sources which the user receives sound from.

In one embodiment the receiver unit is adapted to receive incoming mobile phone and fixed net telephone calls. It is an advantage that the receiver unit may receive mobile phone calls and fixed network telephone calls, because phone calls may then be amplified in the receiver unit.

In one embodiment the receiver unit is adapted to receive incoming mobile phone and fixed net telephone calls which the user has accepted, when the user listens to sound from one of the one or more external devices. It is an advantage that the user can receive and accept phone calls when listening to sound from an external device, because then the user will not miss phone calls which he/she wishes to receive. Furthermore it is an advantage that the user does not have to leave the TV watching position to pickup telephone calls.

In one embodiment a fixed network telephone conversation is received and transmitted between the base unit and the receiver unit via Bluetooth communications by connecting a fixed network telephone line from a wall outlet to the base unit. It is an advantage that a fixed network telephone conversation is communicated between the base unit and the receiver unit by means of Bluetooth, because then the user does not need to hold the telephone receiver to his/her ear, and the user can have the audio signals from the conversation amplified.

In one embodiment a mobile phone conversation is received and transmitted between a mobile phone and the receiver unit via Bluetooth communications.

It is an advantage that a mobile phone conversation is communicated between the base unit and the receiver unit by means of Bluetooth, because then the user does not need to hold the mobile phone to his/her ear, and the user can have the audio signals from the conversation amplified.

The present invention relates to different aspects including the system described above and in the following, and corresponding methods, devices, and/or product means, each yielding one or more of the benefits and advantages described in connection with the first mentioned aspect, and each having one or more embodiments corresponding to the embodiments described in connection with the first mentioned aspect and/or disclosed in the appended claims.

In particular, disclosed herein is a method of transmitting amplified audio signals to a user, the method comprises the steps of:
receiving audio signals wirelessly from at least one of a transmitter unit and a base unit and from one or more external devices by means of a receiver unit, and where the receiver unit is adapted to be worn by the user;
transmitting audio signals wirelessly to the receiver unit by means of the transmitter unit; and
communicating with one or more external devices and communicating wirelessly with the receiver unit by means of the base unit.

### BRIEF DESCRIPTION OF THE DRAWINGS

The above and/or additional objects, features and advantages of the present invention, will be further elucidated by the following illustrative and non-limiting detailed description of embodiments of the present invention, with reference to the appended drawings, wherein:

FIG. 1 shows a system comprising a receiver unit, a transmitter unit and a base unit.

FIG. 2 shows a system comprising a receiver unit, a transmitter unit and a base unit and a hearing aid or headphones.

FIG. 3 shows examples of how the system can be used to transmit and amplify audio signals from external devices.

FIG. 4 shows examples of how audio signals can be transmitted to the user.

### DETAILED DESCRIPTION

In the following description, reference is made to the accompanying figures, which show by way of illustration how the invention may be practiced.

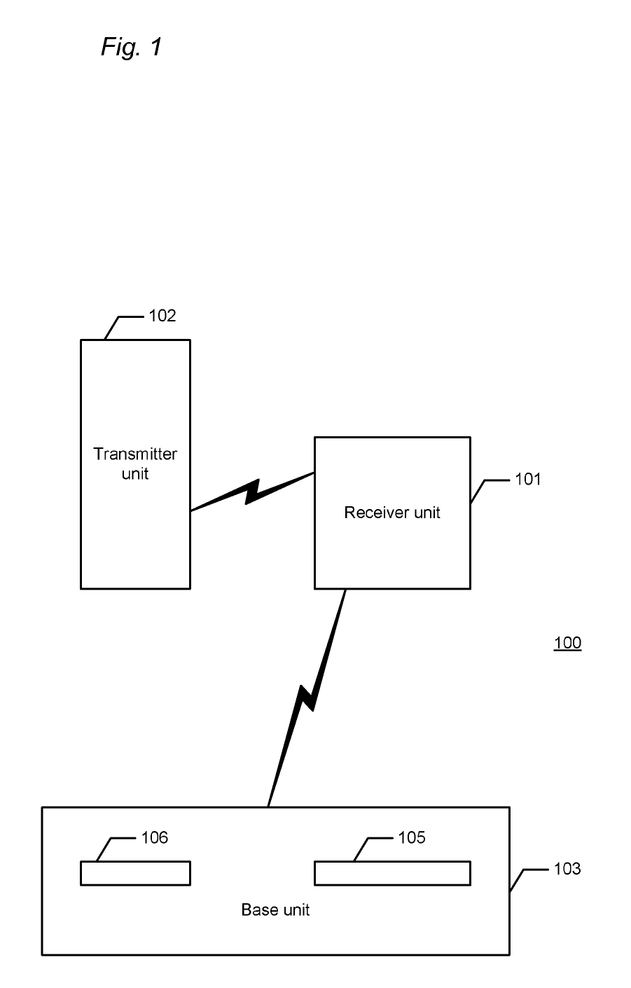

FIG. 1 shows a system 100 comprising a receiver unit 101, a transmitter unit 102, and a base unit 103. The receiver unit 101 can communicate with the transmitter unit 102 and the base unit 103 by means of wireless connections. The communications between the receiver unit 101 and the transmitter unit 102 may be a one-way communication, where the transmitter 102 transmits audio signals to the receiver unit 101. The transmitter unit 102 may transmit audio signals to the receiver unit 101 by means of a wireless digital audio communication with frequency range in the 2.4 GHz band. Alternatively and/or additionally, the transmitter unit may transmit audio signals to the receiver unit by means of Bluetooth communications and/or any other suitable wireless communications means with an ultra low latency, e.g. such as a latency or delay of less than 10 milliseconds, 5 milliseconds, 1 millisecond and/or the like.

The communications between the receiver unit 101 and the base unit 103 may be a two-way communication. The receiver unit 101 may transmit and receive audio signals to and from the base unit 103 by means of Bluetooth communications and the base unit 103 may likewise transmit and receive audio signals to and from the receiver unit 101 by mean of Bluetooth communications. Alternatively and/or additionally, the receiver unit and the base unit may communicate by means of any other suitable wireless communications means.

Furthermore, the base unit 103 may comprise means for charging the transmitter unit 102 and the receiver unit 101. In the base unit 103, a charger seat 105 for the receiver unit 101 and a charger seat 106 for the transmitter unit 102 are shown. Alternatively and/or additionally, means for charging the transmitter unit and/or the receiver unit may be provided in a charger unit arranged separately from the base unit 103.

A wireless digital audio communication may take place within a range of about 15 meters. The range may be dependent upon quality, the surroundings etc. If there is noise from e.g. Bluetooth devices in the surroundings, the range may be less than 15 meters, e.g. such as 5 meters or the like for obtaining a good sound quality.

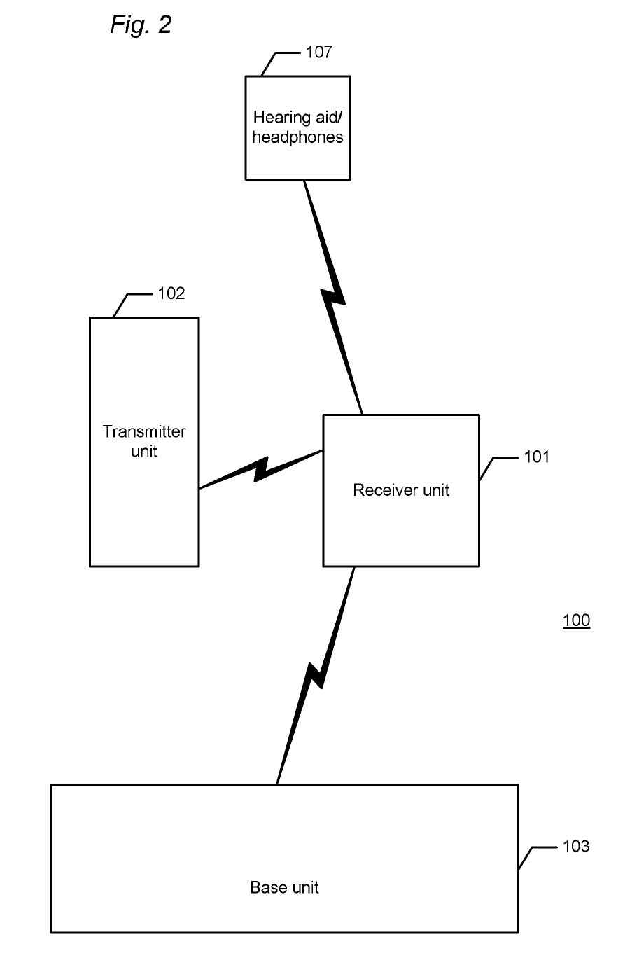

FIG. 2 shows a receiver unit 101, a transmitter unit 102, and a base unit 103. In addition a hearing aid or headphones 107 are shown.

For amplifying audio signals to the user from a second person who is talking, the transmitter unit 102 may transmit audio signals which are captured by one or more microphone(s) in the transmitter unit 102.

The audio signals may be transmitted from the transmitter unit 102 to the receiver unit 101 by means of a wireless digital audio communication with a 2.4 GHz band range. Alternatively and/or additionally the audio signals from the transmitter unit 102 may be transmitted by means of any suitable wireless radio frequency communications means.

The transmitter unit 102 may be held by the second person talking who the user wishes to listen to or have a conversation with. Alternatively, the transmitter unit 102 can be attached to the shirt, a neck strap, a wrist strap and/or the like of the second person talking. Alternatively, the person talking can hold the transmitter unit 102 in his/her hand. Alternatively, the user may hold the transmitter unit 102 and point it in the direction of the talking person (s). The person(s) who is talking may be any one who the user wishes to listen to, such as a person with who the user is having a conversation, or the person who is talking may be a lecturer, a nurse, a doctor etc. Microphone setting may be chosen according to the conditions by selecting omni-directional mode or directional mode using an omni-directional microphone and a directional microphone, respectively.

The hearing aid 107 may receive audio signals transmitted from the receiver unit 101 by means of magnetic transmission. The magnetic transmission may be provided by means of telecoil transmission. The receiver unit 101 may hang in a neckloop around the neck of the user, and the neckloop may be an induction coil providing telecoil transmission. In order to use the system with telecoil transmission, the hearing aid 107 should be equipped with a telecoil and fitted by the hearing aid dispenser. The system may work with any hearing aid equipped with telecoil regardless of brand and model of the hearing aid. Furthermore, the system may work with binaural hearing aid fitting where two hearing aids are worn simultaneously, one hearing aid on each ear.

Telecoils are comprised of a metal core around which an ultra-fine wire is coiled. Telecoils are also called induction coils because when the coil is placed in an electromagnetic field, an alternating electrical current is induced in the wire. The telecoil picks up electromagnetic energy and transforms it to electrical energy.

The hearing aid 107 may be used with magnetic transmission of audio signals only, e.g. by means of telecoil transmission. Alternatively, the hearing aid 107 may be used with both magnetic transmission and microphone(s) in the hearing aid 107.

When the system 100 is used with headphones 107 instead of a hearing aid, a cord may connect the receiver unit 101 with the headphones 107 for providing audio signals from the receiver unit 101 to the headphones 107.

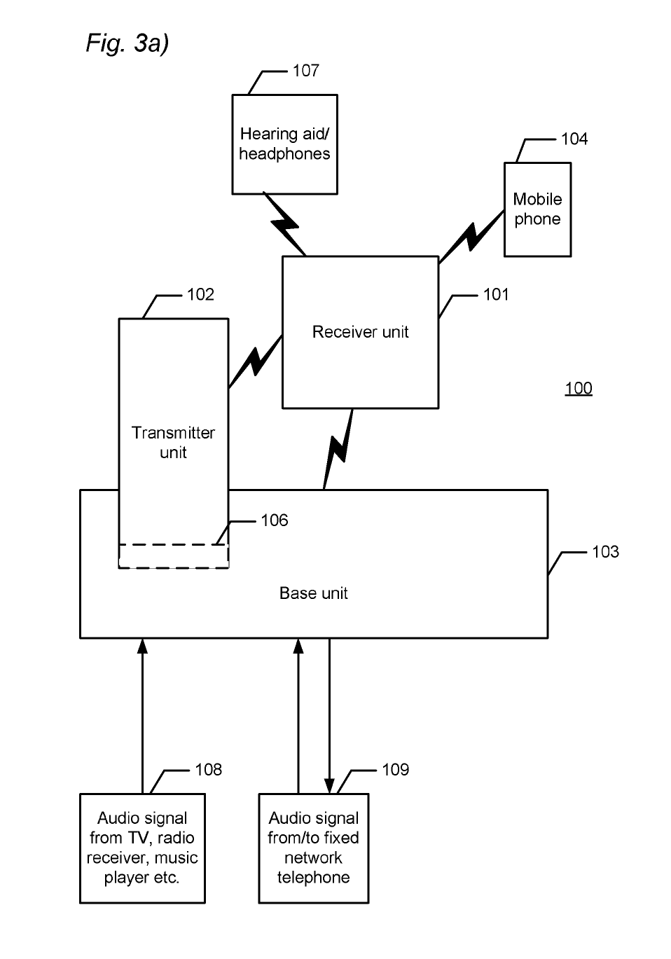

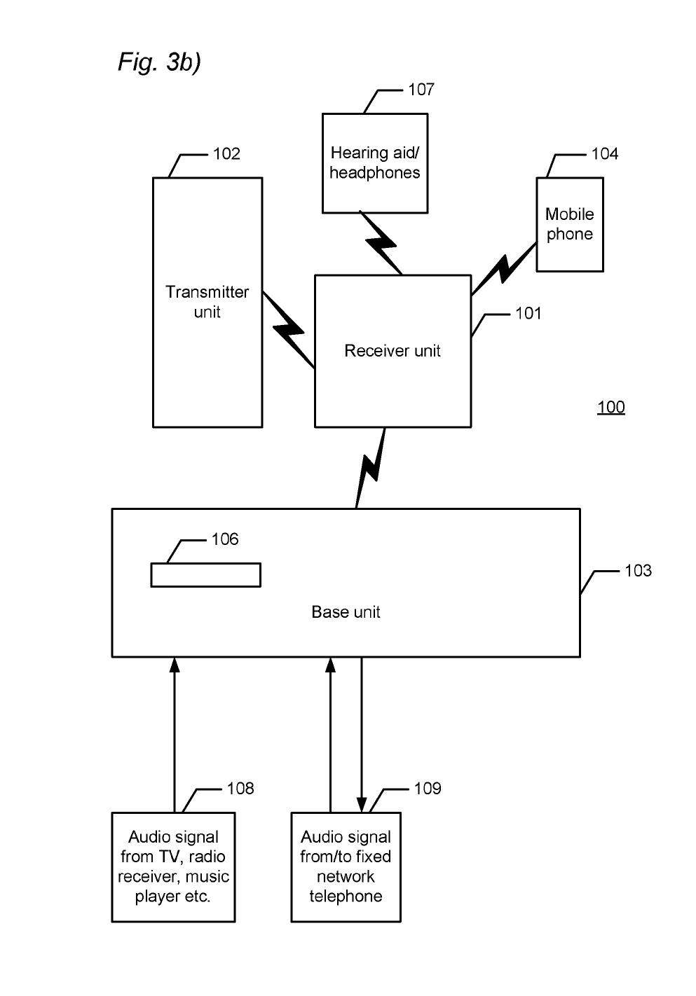

FIG. 3a) shows an example of how the system 100 can be used to transmit and amplify audio signals from a television (TV) to the user through the user's hearing aid 107 or headphones 107. The user may wear the receiver unit 101 around his/her neck while receiving audio signals from the TV.

The output signal 108 from the TV should be connected to the base unit 103 e.g. by means of a suitable cord. Sound 108 from the TV may then be transmitted via the base unit 103 through the transmitter unit 102, which is docked in its seat 106 in the base unit 103, to the receiver unit 101 by means of wireless radio frequency communications. The wireless radio frequency communications may be a wireless digital audio communications with a 2.4 GHz band range and/or any other suitable wireless radio frequency communications, which has ultra low latency for ensuring that the audio signal 108 from the TV is not delayed or is not substantially delayed. The base unit 103 may comprise a wireless digital audio channel management system for pairing the transmitter unit 102 and the receiver unit 101 to the same communications channel.

The user may accept and receive incoming mobile phone calls 104 and fixed net telephone calls 109 via the receiver unit 101, while the user is listening to audio signals 108 from a TV. When the mobile phone 104 or fixed net telephone is ringing, a ringing tone may be heard in the hearing aid 107 or headphones 107, simultaneously with the audio signals 108 from the TV. The user may accept the phone call by pushing a button on the receiver unit 101.

Furthermore, the receiver unit 101 allows the user to listen into an ongoing phone call performed by another person who uses the fixed network telephone.

Furthermore, the system 100 can be used to transmit and amplify audio signals 108 from another sound source than a TV to the user through the user's hearing aid 107 or headphones 107. Such sound source may be a radio receiver such as an FM radio receiver, an AM radio receiver, a DAB radio receiver, or a music player such as a CD player, an MP3 player etc. The audio signals 108 from a radio receiver or a music player may be transmitted to the receiver unit 101 by means of any suitable wireless radio frequency communications means, e.g. such as Bluetooth and/or the like.

Alternatively and/or additionally, a Direct Audio Input (DAI) allows the hearing aid 107 to be directly connected to an external audio source such as a CD player, MP3 player, radio receiver or an assistive listening device, whereby the user may listen to audio signals received directly from a sound source.

FIG. 3b) shows an example of how the system 100 can be used to transmit and amplify audio signals 109 from a fixed network telephone conversation to the user through the user's hearing aid 107 or headphones 107. The user may wear the receiver unit 101 around his/her neck while receiving and transmitting audio signals 109 from and to the fixed network telephone. The fixed net telephone line should be connected from the wall outlet to the base unit 103. Audio signals 109 from the fixed network telephone is received and transmitted between the base unit 103 and the receiver unit 101 using Bluetooth communications and/or any other suitable wireless radio frequency communications.

The transmitter unit 102 does not have to be docked in its seat 106 in the base unit 103 in order for the system to transmit and receive fixed network telephone conversations, because the transmitter unit 102 may not be involved in the transmission of fixed network telephone calls.

Furthermore, the user may accept a call from a mobile phone 104, while the user is having a conversation on a fixed network telephone. Thus, the user may switch between mobile phone call and fixed net telephone call.

Furthermore, the receiver unit 101 may be used to provide an amplified mobile phone conversation to the user independent of fixed network telephony. The mobile phone 104 should be paired and connected to the receiver unit 101. Mobile telephone conversation is received and transmitted between the mobile telephone 104 and the receiver unit 101 via Bluetooth communications.

The Bluetooth communications setup may be established in two phases. In the first phase, the units or devices communicating by means of Bluetooth are paired with each other. In phase two the units or devices can connected with each other. A set of Bluetooth unit or devices may be paired but not connected. However, in the present system connecting is automatic, and thus the connecting happens automatically if the units or devices are within range of each other and already paired.

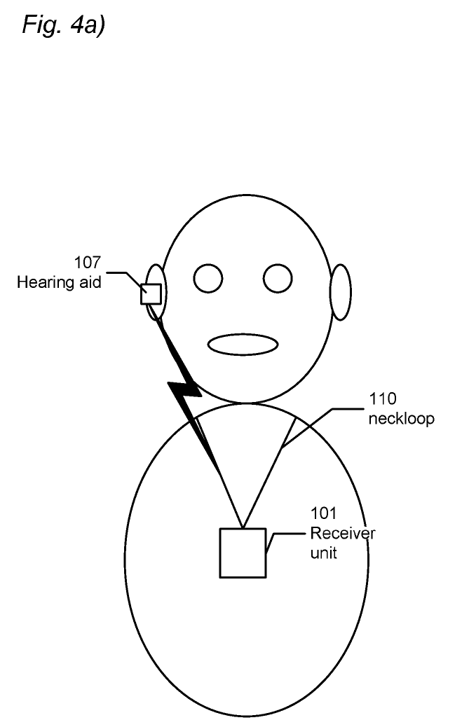

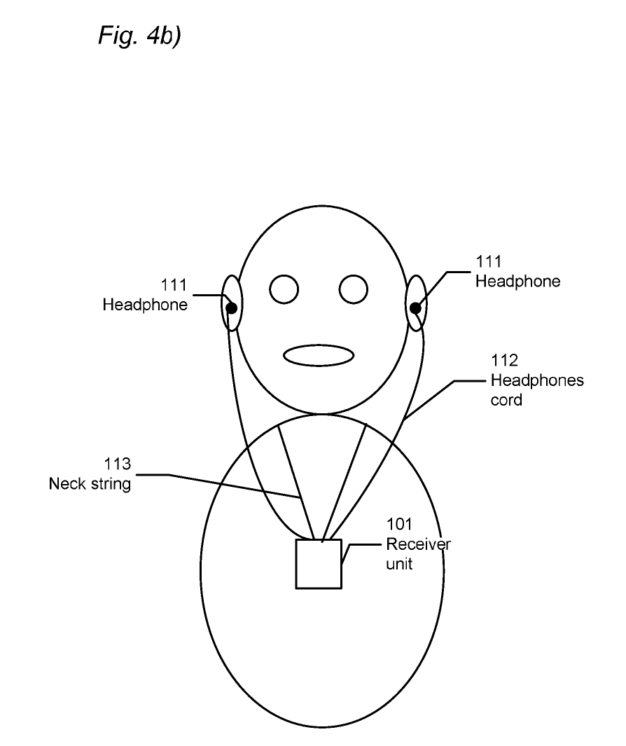

FIG. 4 shows an example of how the audio signals from the receiver unit can be transmitted to the user.

In FIG. 4a) the user is shown with a hearing aid 107. Even though only one hearing is shown, it is understood that the user may wear hearing aids in both ears. A neckloop 110 is attached to the receiver unit 101, and the audio signals from the receiver unit 101 are transmitted to the hearing aid 107 by means of magnetic transmission. The magnetic transmission may be provided by means of telecoil transmission. The receiver unit 101 may hang in the neckloop 110 around the neck of the user, and the neckloop 110 may be an induction coil providing telecoil transmission. In order to use the system with telecoil transmission, the hearing aid 107 should be equipped with a telecoil fitted by the hearing aid dispenser.

In FIG. 4b) the user is shown with a pair of headphones 111 in his/her ears. A cord 112 connects the headphones 111 with the receiver unit 101, and the audio signals from the receiver unit 101 are transmitted to the headphones 111 by means of wired transmission through the cord 112. The receiver unit 101 may hang in a neck string 113, a neckloop and/or the like around the neck of the user.

In relation to both FIG. 4a) and FIG. 4b), the receiver unit 101 may receive audio signals from the transmitter unit, the base unit, a mobile telephone etc. as described in relation to the previous figures.

The system as described above comprises a receiver unit, a transmitter unit and a base unit, which will be described in more details below.

The receiver unit may comprise a micro processor; volume control; automatic gain control; an amplifier for amplifying the received audio signals; a battery; a charger part for connecting to the means for charging in the base unit or in a separate charger unit; a receiver part for receiving wireless digital audio signals from the transmitter unit; a Bluetooth receiver part and a Bluetooth transmitter part for receiving Bluetooth signals and transmitting Bluetooth signals, respectively, from and to the base unit, the transmitter unit, a mobile phone and any other suitable external device. The receiver unit may comprise a display, keys or buttons on its exterior surface for enabling the user to control communications mode, volume etc. Furthermore, the receiver unit may comprise a neckloop, a neck string and/or any other suitable means adapted for hanging the receiver around the neck of the user.

The transmitter unit may comprise a micro processor control; a battery; a charger part for connecting to the means for charging in the base unit or in a separate charger unit; a transmitter part for transmitting wireless digital audio signals to the receiver unit and/or a Bluetooth transmitter part or any other suitable radio frequency transmitter part for transmitting radio frequency signals wirelessly to the receiver unit; and microphones for converting sound waves into electrical audio signals. The transmitter unit may comprise a directional microphone and an omni-directional microphone. The transmitter unit may comprise a display, keys or buttons on its exterior surface for enabling the user or a second person to control the microphone mode, volume etc. Furthermore, the transmitter unit may comprise a neck string and/or any other suitable means adapted for hanging the transmitter around the neck or wrist of a second person or the user. The transmitter unit is also adapted to be arranged on a surface.

The base unit may comprise a wireless digital audio channel management system for pairing the transmitter unit and the receiver unit to the same communications channel; a Bluetooth receiver part and a Bluetooth transmitter part for receiving and transmitting Bluetooth signals, respectively, from and to the receiver unit, a fixed network telephone and any other suitable external device; an interface for connecting the output signal from a TV; a telephone interface for connecting a fixed network telephone by connecting a cord to the outlet and a cord to a fixed network telephone in series; and power supply connection. Furthermore, the base unit may comprise means for charging the transmitter unit and/or the receiver unit, and the transmitter unit and/or receiver unit may be docked in respective charger seats in the base unit or in a separate charger unit.

Although some embodiments have been described and shown in detail, the invention is not restricted to them, but may also be embodied in other ways within the scope of the subject matter defined in the following claims. In particular, it is to be understood that other embodiments may be utilised and structural and functional modifications may be made without departing from the scope of the present invention.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A system for transmitting amplified audio signals to a user, wherein the system comprises a receiver unit, a transmitter unit and a base unit, wherein
the receiver unit is adapted to receive audio signals wirelessly from at least one of the transmitter unit and the base unit and from one or more external devices, and where the receiver unit is adapted to be worn by the user;
the transmitter unit is adapted to transmit audio signals wirelessly to the receiver unit; and
the base unit is adapted to communicate with one or more external devices and adapted to communicate wirelessly with the receiver unit.

2. A system according to claim 1, wherein the system is adapted to be used together with a hearing aid.

3. A system according to claim for 2, wherein the system is adapted to be used together with headphones.

4. A system according to claim 1, wherein the units are adapted to communicate by means of radio frequency communications.

5. A system according to claim 4, wherein the radio frequency communications is by means of Bluetooth radio frequency communication.

6. A system according to claim 4 or 5, wherein the radio frequency communications is by means of a wireless digital audio system operating in the 2.4 GHz band.

7. A system according to claim 4, wherein the radio frequency communications has an ultra low latency.

8. A system according to claim 7, wherein the radio frequency communications has a latency of less than 10 milliseconds.

9. A base unit for use in a system according to claim 1, wherein the base unit is adapted to be stationary arranged.

10. A transmitter unit for use in a system according to claim 1, wherein the transmitter unit is arranged in a position from the group consisting:
held by a second person;
worn by a second person;
held by the user;
worn by the user;
placed in the base unit;
placed on a surface.

11. A receiver unit for use in a system according to claim 1, wherein the receiver unit is adapted to be worn in a neckloop around the neck of the user.

12. A receiver unit for use in a system according to claim 11, wherein the neckloop comprises magnetic means for providing communications.

13. A receiver unit for use in a system according to claim 11 or 12, wherein the receiver unit is adapted to communicate with a hearing aid worn by the user by means of said magnetic means.

14. A receiver unit for use in a system according to claim 1, wherein the receiver unit comprises a Bluetooth receiver.

15. A receiver unit for use in a system according to claim 1, wherein the receiver unit comprises a Bluetooth transmitter.

16. A receiver unit for use in a system according to claim 1, wherein the receiver unit comprises a wireless digital audio receiver with frequency range in the 2.4 GHz band.

17. A transmitter unit for use in a system according to claim 1, wherein the transmitter unit comprises a wireless digital audio transmitter with frequency range in the 2.4 GHz band.

18. A transmitter unit for use in a system according to claim 1, wherein the transmitter unit comprises an omni-directional microphone for capturing sound waves from a plurality of directions.

19. A transmitter unit for use in a system according to claim 1, wherein the transmitter unit comprises a directional microphone for capturing sound waves from one direction.

20. A base unit for use in a system according to claim 1, wherein the base unit comprises a charger unit adapted to charge the receiver unit and the transmitter unit.

21. A base unit for use in a system according to claim 1, wherein the base unit comprises a Bluetooth receiver.

22. A base unit for use in a system according to claim 1, wherein the base unit comprises a Bluetooth transmitter.

23. A base unit for use in a system according to claim 1, wherein the base unit comprises a wireless digital audio channel management system for pairing the transmitter unit and the receiver unit to the same communications channel.

24. A base unit for use in a system according to claim 1, wherein the base unit comprises means for receiving audio signals from an external device through an audio line input.

25. A base unit for use in a system according to claim 1, wherein the base unit comprises means for receiving audio signals from a television.

26. A base unit for use in a system according to claim 1, wherein the base unit comprises means for transmitting and receiving audio signals to and from a fixed network telephone.

27. A system according to claim 1, wherein the one or more external device(s) is/are from the group consisting of:
a mobile phone;
a fixed network telephone;
a television;
a radio receiver;
a music player;
a Bluetooth headset.

28. A system according to claim 1, wherein the receiver unit is adapted to receive incoming mobile phone and fixed net telephone calls.

29. A system according to claim 1, wherein the receiver unit is adapted to receive incoming mobile phone and fixed net telephone calls which the user has accepted, when the user listens to sound from one of the one or more external devices.

30. A system according to claim 1, wherein a fixed network telephone conversation is received and transmitted between the base unit and the receiver unit via Bluetooth communications by connecting a fixed network telephone line from a wall outlet to the base unit.

31. A system according to claim 1, wherein a mobile phone conversation is received and transmitted between a mobile phone and the receiver unit via Bluetooth communications.

32. A method of transmitting amplified audio signals to a user, the method comprises the steps of:
receiving audio signals wirelessly from at least one of a transmitter unit and a base unit and from one or more external devices by means of a receiver unit, and where the receiver unit is adapted to be worn by the user;
transmitting audio signals wirelessly to the receiver unit by means of the transmitter unit; and
communicating with one or more external devices and communicating wirelessly with the receiver unit by means of the base unit.
